(19) United States
(12) Patent Application Publication
(10) Pub. No.: US 2019/0043122 A1
(43) Pub. Date: Feb. 7, 2019

(54) DOUBLE REAL-TIME BIDDING AT A BRICK AND MORTAR STORE

(71) Applicant: Intel Corporation, Santa Clara, CA (US)

(72) Inventors: Siew Wen CHIN, Penang (MY); Heng Kar LAU, Penang (MY); Addicam SANJAY, Gilbert, AZ (US); Shao-Wen YANG, San Jose, CA (US)

(21) Appl. No.: 15/855,883

(22) Filed: Dec. 27, 2017

(51) Int. Cl. G06Q 30/08; G06Q 30/02

(52) U.S. Cl. CPC G06Q 30/08; G06Q 30/0222; G06Q 30/0224; G06Q 30/0267; G06Q 30/0261; G06Q 30/0255

(57) ABSTRACT

Systems and methods for double real-time bidding at a brick and mortar store are disclosed. The systems may include a shopper tracking system for tracking a plurality of shoppers, an electronic sign for displaying messages offering products for auction, and a real-time bidding system for receiving bids to sell an offered product from a plurality of sellers and bids to purchase the product from the plurality of shoppers. Shopping behavior data may be collected by the shopper tracking system from the plurality of shoppers, and used by the real-time bidding system to select the messages offering products.

### TECHNICAL FIELD

Embodiments described herein generally relate to the fields of retail technology, and in particular, to systems and methods for electronically tracking multiple shoppers and their behaviors within a brick and mortar store, supplying targeted electronic messaging in response to their behaviors, and receiving responses to the targeted electronic messaging from at least a subset of the multiple shoppers for double real-time bidding.

### BACKGROUND

Online shopping is increasingly popular, often to the detriment of existing brick and mortar stores. An increase in smartphone adoption and the coverage of mobile networks have created ubiquitous shoppers. Roughly 86% of 18-24 year olds own smartphones, closely followed by 85% of 25-34 year olds. Ebay and Amazon have increasingly become popular destinations with shoppers. Even a large retailer, Walmart, has an online store and has added ShippingPass, for $50/year, to compete with Amazon and its Prime membership. Many shoppers nowadays go to a physical store just to look at a product they intend to buy online, effectively turning physical stores into showrooms.

A given product may be offered by multiple sellers, with multiple buyers desiring to obtain the product. A double auction system, where sellers bid minimum sale prices and buyers bid maximum purchase prices, can be effective to sell the product at a mutually agreeable price that optimizes the number of units of the product sold while maximizing the sale price for the sellers.

### BRIEF DESCRIPTION OF THE DRAWINGS

FIG. 1 is a block diagram of the components of a system for targeted electronic messaging for double real-time bidding at a brick and mortar store, according to various embodiments.

FIG. 2 is a block diagram of the components and data flow of some embodiments of the system depicted in FIG. 1, particularly showing the components and flow of the shopper tracking system, according to some embodiments.

FIG. 3 is a data flow diagram of a double auction that may be executed at least in part by the real-time bidding system depicted in FIG. 1, according to some embodiments.

FIG. 4A is a front view of an example electronic sign that may be useful with the system of FIG. 1, depicting physical slots for messages, according to some embodiments.

FIG. 4B depicts time slots for messages in the electronic sign of FIG. 4A, according to some embodiments.

FIG. 5 depicts how the system of FIG. 1 can use RFID signal interference to track shopper behavior and location within a brick and mortar store, according to some embodiments.

FIG. 6A is a screen shot of an example interface seen by a potential seller to bid on a chance to sell a product up for auction in some embodiments.

FIG. 6B is a screen shot of an example interface seen by a potential buyer to bid on a product available for sale in some embodiments.

FIG. 7 is a block diagram of an example computer that can be used to implement some or all of the components of the system of FIG. 1, according to some embodiments.

FIG. 8 illustrates an domain topology for respective internet-of-things (IoT) networks coupled through links to respective gateways, according to an example;

FIG. 9 illustrates a cloud computing network in communication with a mesh network of IoT devices operating as a fog device at the edge of the cloud computing network, according to an example;

FIG. 10 illustrates a block diagram of a network illustrating communications among a number of IoT devices, according to an example; and

FIG. 11 illustrates a block diagram for an example IoT processing system architecture upon which any one or more of the techniques (e.g., operations, processes, methods, and methodologies) discussed herein may be performed, according to an example.

### DETAILED DESCRIPTION

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The disclosed embodiments provide ways to implement a double auction system within a brick and mortar store. Multiple sellers of a given product may supply bids or a bid range of pricing at which a given seller is willing to sell a product. When an auction is conducted for the given product, shoppers in the brick and mortar store likewise may submit bids against the product for a price they are willing to pay. A double auction is conducted to determine a price that may optimize sales of all quantities of the product across the various bidding sellers.

Selection of a given product for sale from a plurality of sellers may be accomplished with reference to the shopping behaviors of a selected plurality of shoppers. Likewise, selection of the plurality of shoppers may be performed on the basis of shoppers' collective shopping behavior data, with a plurality determined on the basis of common shopping habits. The plurality of shoppers may be tracked within a brick and mortar store, by both collecting relevant data concerning their shopping behaviors, and physically tracking their locations within the brick and mortar store. Location data is useful for further refining the collected shopping behavior data.

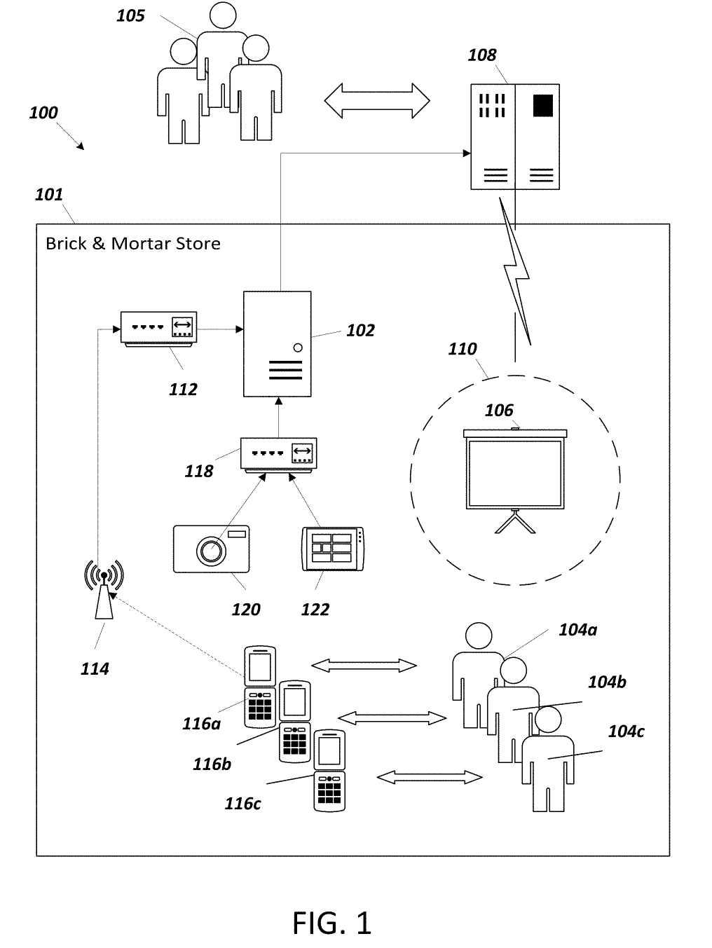

As seen in FIG. 1, an embodiment of a system 100 provides double real-time bidding at a brick and mortar store 101, according to some embodiments. System 100 may include a shopper tracking system 102, which may be located within the brick and mortar store 101 (also referred to herein simply as “store 101”). Shopper tracking system 102 may collect shopping behavior data and bids from a plurality of shoppers 104a, 104b, and 104c as well as track the physical locations of each of the plurality of shoppers 104a to 104c while within the brick and mortar store 101. An electronic sign 106 may be disposed within the brick and mortar store 101 to display electronic messages that may include offers to bid on various products. Shopper tracking system 102 may continuously provide shopping behavior data of each of the plurality of shoppers 104a to 104c to a real time bidding (RTB) system 108 remote from the brick and mortar store 101. Shopper tracking system 102 may also, in some embodiments, supply the physical location of each of the plurality of shoppers 104a to 104c to RTB system 108. Location data may likewise be supplied continuously, periodically, or when the plurality of shoppers is proximate to an electronic sign 106. Shopper tracking system 102 may also provide the RTB system 108 with bids received from each of the plurality of shoppers 104a to 104c in response to displayed messages, which will be discussed in greater detail herein.

In addition to receiving shopping behavior data, physical locations, and bids from each of the plurality of shoppers 104, 104b and 104c, RTB system 108 may receive various bids from one or more sellers 105 of products, which may be offered via electronic messages as described further herein. The various sellers 105 may be remote from the store 101 as well as shopper tracking system 102, may be located within store 101, or a combination of both. Sellers 105 may interact with system 100 via remote means, such as an application or web page. For example, where such application or web page may communicate over the Internet, sellers 105 may be located anywhere that access to the Internet is available.

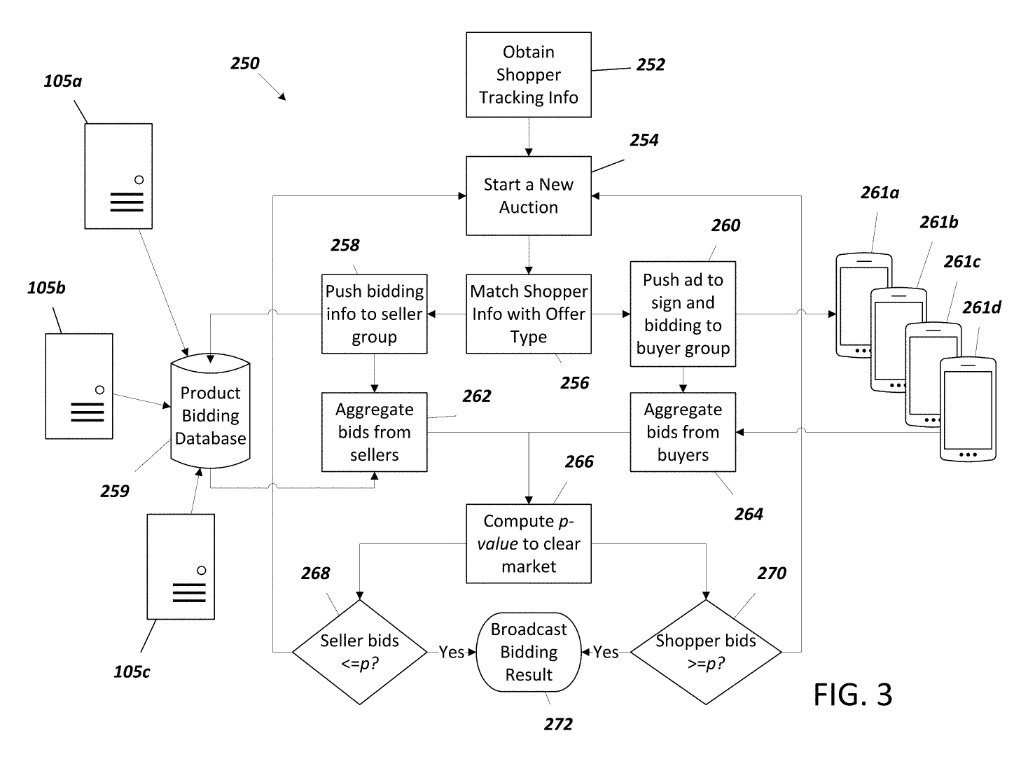

It should be understood that shoppers 104a, 104b and 104c, and sellers 105a, 105b and 105c (seen in FIG. 3) are only intended to be representative. Embodiments may support any number of plurality of shoppers and plurality of sellers, with the scale of supported shoppers and sellers being limited by the specifics of a given implementation of system 100. Furthermore, a given plurality of shoppers 104a, 104b and 104c may form on a spontaneous and ad hoc basis. Plurality of shoppers 104a, 104b and 104c may have nothing in common other than being geographically within a store 101, being proximate to a given electronic sign 106, and/or sharing some commonality in shopping behavior data. System 100 may on its own determine to treat shoppers 104a to 104c that share a geographic proximity to an electronic sign 106 and some shopping behavior as a plurality for purposes of delivering a message to the electronic sign 106. Shoppers 104a to 104c may not have any input to system 100 to specifically be considered within a plurality of shoppers.

Shopper tracking system 102 may provide a notification to the RTB system 108 when the plurality of shoppers 104a to 104c are within a predetermined distance 110 to electronic sign 106. This notification may cause the RTB system 108 to display an electronic message in or during a message slot of electronic sign 106 for the plurality of shoppers. The electronic message may include one or more products available upon which each of the plurality of shoppers 104a to 104c may bid, and which may be offered for sale from a plurality of sellers 105. The electronic message and available product(s) may be selected on the basis of the shopping behavior data. In some embodiments, the message selection may be based upon the shopping behavior data of all of the plurality of shoppers. In other embodiments, the message selection may be based upon the shopping behavior data of a subset of the plurality of shoppers. In still other embodiments, the message selection may be based upon the shopping behavior data of only one of the plurality of shoppers. In embodiments, the message slot may be a physical slot or a time slot.

Although a single electronic sign 106 is disclosed, it should be appreciated that system 100 may be configured with any arbitrary number of electronic signs 106, which may be distributed throughout the brick and mortar store 101. In such embodiments, each electronic sign 106 is potentially capable of receiving its own set of electronic messages, independent from the other electronic signs 106. Other embodiments may have all electronic signs 106 configured to receive and display identical messages, depending upon the particulars of a given implementation of system 100. In embodiments that implement multiple electronic signs 106, shopper tracking system 102 may provide notifications specific to each electronic sign 106 as one or more of the plurality of shoppers 104a to 104c approach each electronic sign 106. Further, some embodiments may track multiple pluralities of shoppers 104a to 104c, where each plurality of shoppers 104a to 104c may be proximate to a different electronic sign 106. Still further, other embodiments may track multiple pluralities of shoppers 104a to 104c that each may be proximate to a single electronic sign 106. Multiple messages may accordingly be displayed upon the electronic sign 106 (as will be described in greater detail below), each potentially offering a different product selected for its associated plurality of shoppers 104a to 104c.

Brick and mortar store 101 can be any building suitably sized to accommodate the on-site components of system 100, such as the electronic signs, sensors to track pluralities of shoppers, and so forth. Where system 100 employs sensors and techniques that allow tracking the location of a shopper 104a, 104b or 104c with sub-meter meter accuracy, system 100 can be employed in stores 101 that have a relatively small physical footprint, common in many so-called “mom and pop” stores. Likewise, system 100 can be scaled to accommodate stores that have a footprint stretching into hundreds of thousands of square meters, as is typical of many “big box” stores, such as those operated by Target or Walmart. Depending on the type of sensors employed and desired tracking accuracy, stores 101 with larger footprints may require the number of sensors employed with system 100 to be correspondingly increased to an appropriate ratio to the area of store 101, to provide acceptable coverage.

Still further, a single system 100 may be scaled to accommodate deployment across multiple stores 101, where each store 101 may be geographically separate for other stores 101. Scaling system 100 may, in some embodiments, entail deployment of multiple instances of shopper tracking system 102 associated with a single system 100. An example of such a deployment could be considered for a nationwide chain store, where a single system 100 may be scaled and deployed across all stores 101 in the chain, potentially allowing shopping behavior data to be collected and aggregated across all stores 101 in the chain, and/or potentially allowing shopping behavior data from a single shopper 104a, 104b, or 104c to be tracked and gathered across visits to different stores 101 in the chain, such as where a shopper 104a, 104b or 104c may visit several different Walmarts or Targets. Where data is collected and aggregated from a single shopper, this data may be combined with data from other shoppers in a plurality of shoppers 104a to 104c by system 100 for determining messages to display.

The phrase “brick and mortar” should be understood to be figurative for a general physical area, and not as limiting system 100 to embodiments that are implemented within a store constructed from actual bricks and mortar. Store 101 may be constructed using any suitable building material(s) and techniques as are now known or later developed in the building trades, such as steel, concrete, or wood-frame (aka stick-built), to name a few of the most common methods of construction, or temporary structures, such as tents, canopies, modular buildings, and the like. Moreover, store 101 need not be an actual, enclosed brick and mortar store. In some embodiments, system 100 may be deployed to cover an unenclosed geographic region, such as may be encountered at a farmer's market, county or state fair, or outside bazaar. In such deployments, the phrase “brick and mortar” may simply refer to a defined geographic region, without regard to a particular structure. In some embodiments such an area could cover multiple structures, such as a fair or expo where structures such as trailers and/or modular buildings may be deployed within a wider geographic area, and tracking of shopping behavior across multiple vendors and structures is desired.

Similarly, system 100 need not be deployed to cover the entire area enclosed by a store 101. Embodiments of system 100 may be deployed in only a portion or a few portions of store 101. For example, most stores have an area or areas designated for employees only, such as back areas where surplus stock is kept, store offices, and breakrooms, or other areas where customers are allowed but do not have saleable goods, such as restrooms. In such stores 101, system 100 might only be deployed in physical areas where customers are expected to engage in behavior relevant to tracking, such as a retail floor. Further, where store 101 is a multi-use facility such as a convention center or expo grounds, multiple instances of system 100 may be deployed at various separate geographic locations within store 101, such as different convention halls.

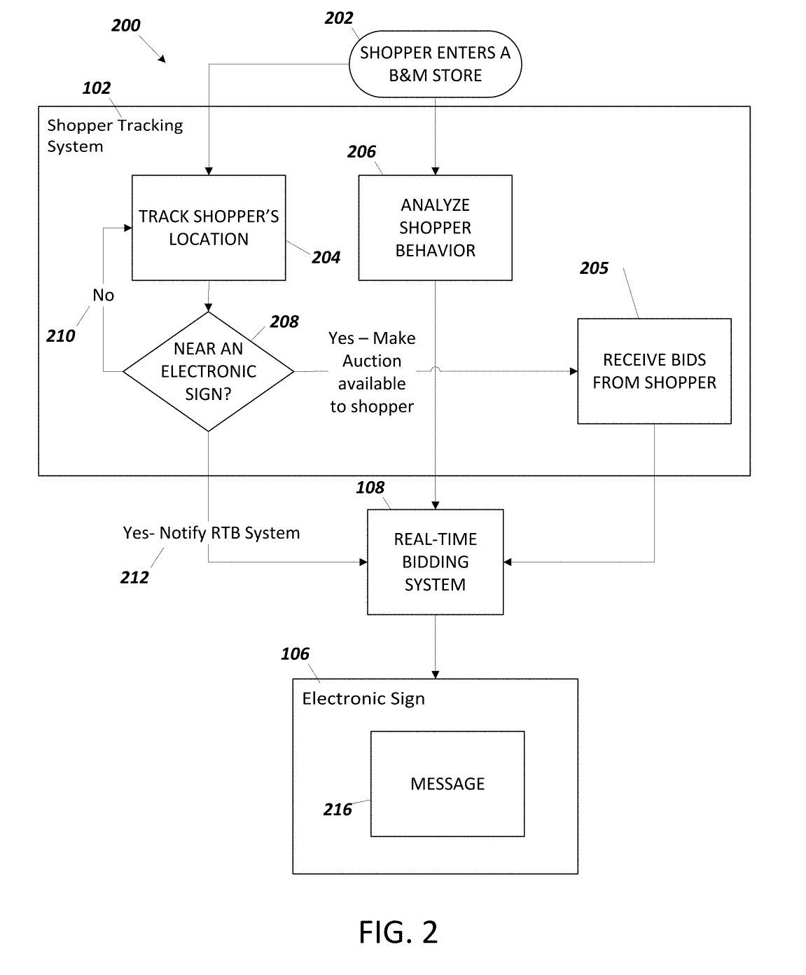

FIG. 2 demonstrates one possible process flow 200 for an embodiment of system 100 as shopper tracking system 102 interacts with real time bidding system 108 to provide messages for display on electronic sign 106 and to process the corresponding double auction. Process flow 200 may start when the plurality of shoppers 104a to 104c (a single shopper of the plurality of shoppers will be referred to herein as “shopper 104”) enters into brick and mortar store 101 in block 202. As mentioned above, this may be a logical construct, with system 100 realizing the plurality of shoppers 104a to 104c once the shoppers 104a to 104c become proximate to an electronic sign 106. Shopper tracking system 102 may commence tracking of each shopper's 104 location in block 204, and may analyze each shopper's 104 shopping behavior in block 206 to obtain shopping behavior data. As each shopper 104 moves through brick and mortar store 101, shopper tracking system 102 may continuously supply shopping behavior data of each shopper 104 to real time bidding system 108. Shopper tracking system 102 may also continuously determine 208 the distance between each shopper 104 and an electronic sign 106. If no shopper 104 is within the predetermined distance 110 from electronic sign 106, shopper tracking system 102 may iterate back 210 and return to monitoring the location of each shopper 104 in block 204.

Once shopper tracking system 102 determines that a plurality of shoppers 104a to 104c are within the predetermined distance 110 from electronic sign 106, shopper tracking system 102 may notify 212 the real time bidding system 108 of the location of each of the plurality of shoppers 104a to 104c. In other embodiments, shopper tracking system 102 may notify RTB system 108 any time any given shopper comes within the predetermined distance 110. In such embodiments, RTB system 108 may then, on the basis of each shopper's associated shopping behavior data, determine a plurality of shoppers 104a to 104c that share some commonality in data. Once a plurality of shoppers 104a, 104b and 104c has been determined, RTB system 108 may select and send a message 216 to electronic sign 106 for display within the proximity of plurality of shoppers 104a to 104c. Each of the plurality of shoppers 104a, 104b and/or 104c can then chose to respond to message 216, such as by bidding on an item offered via message 216. Following determining 208 that at last a subset of the plurality of shoppers 104a to 104c is within proximity of an electronic sign, shopper tracking system 102 may receive bids 205 from each of the plurality of shoppers 104a to 104c that are placed in response to message 216.

FIG. 3 details the data flow 250 for an embodiment of the real-time bidding system 108 as it executes a double auction on a selected plurality of shoppers 104a to 104c, as detailed with respect to FIG. 2. Shopping behavior data may be obtained in block 252 via shopper tracking system 102, as described above. Upon receiving a notification from shopper tracking system 102 that a plurality of shoppers 104a to 104c is proximate to an electronic sign 106 or selection of a plurality of shoppers 104a to 104c by RTB system 108, RTB system 108 may initiate a new auction in block 254. RTB system 108 may analyze the shopping behavior data received from shopper tracking system 102. RTB system 108 may then select a message with an offer for a product available for sale from a plurality of sellers 105a, 105b, and 105c, for example, that fits within the profile of shoppers 104a to 104c deteremined from the shopping behavior data. A message is thus selected for display by RTB system 108 that is likely to be relevant to plurality of shoppers 104a to 104c. The placement of the message selling the product is pushed to sellers 105a to 105c in block 258, and the message itself is pushed to electronic sign 106 to be placed before shoppers 104a to 104c in block 260. At the same time, shopper tracking system 102 may accept bids from shopper 104a to 104c in response to the pushed message, for supply to RTB system 108.

Once the message offering the product to be bid upon is pushed to electronic sign 106, the auction may commence. Sellers 105a to 105b may have submitted bids to sell the offered product in advance of the message display, which bids may be stored within product bidding database 259. Such a configuration may allow sellers 105a, 105b and/or 105c to set up products for sale and bid ranges in advance of messages and offers being pushed to shoppers 104a to 104c, which may then be automatically processed once a relevant message is pushed and an auction commenced. Alternatively, sellers 105a, 105b and/or 105c may indicate products and quantity available, but provide bids for sell prices contemporaneously with an auction and the receipt of bids to purchase from shoppers 104a, 104b and/or 104c. As the auction progresses, shoppers 104a to 104c may submit bids for the offered product, which may be collected by shopper tracking system 102.

Once the auction closes, the bids from the sellers 105a to 105c for sale prices may be aggregated in block 262, and the bids to purchase from shoppers 104a to 104c may be aggregated in block 264. In block 266, the aggregated bids from blocks 262 and 264 may be analyzed, and a p value to clear the market may be computed. This p value may be computed as the value that will optimize the number of products sold and also optimize the sale price of the products. In some embodiments, this value is the median value from a range of values bounded by the lowest bid sale price at the bottom and the highest bid purchase price at the top. A person skilled in the art will recognize that, in some auctions, there may be a subset of bids to sell that exceed the determined p value, and/or a subset of bids to buy that are below the p value. Those bids to sell that exceed, and bids to buy that are below, the p value will be rejected as non-winning. It will further be recognized by a person skilled in the art that, in cases where the lowest bid sale price is higher than the highest bid purchase price, there is no overlap in pricing and thus the auction would fail, as no buyer is willing to pay for the offered product at a price required by a seller.

For the subset of bids to sell below 268 and subset of bids to buy above 270 the p value, RTB system 108 will determine them to be winning bids, and notify in block 272 the various bidding sellers and shoppers with winning bids of their winning status. Following notification, the system 100 may automatically complete the transactions of the winning bidders (both seller and shopper), or in some embodiments, each winning bidder may be enabled to manually complete the transaction, such as via an app on a smartphone that may also be used to accept bids from a given shopper 104. In some further embodiments, each winning bidder may be enabled to manually complete the transaction within store 101, such as at a point-of-sale terminal or checkout kiosk or stand.

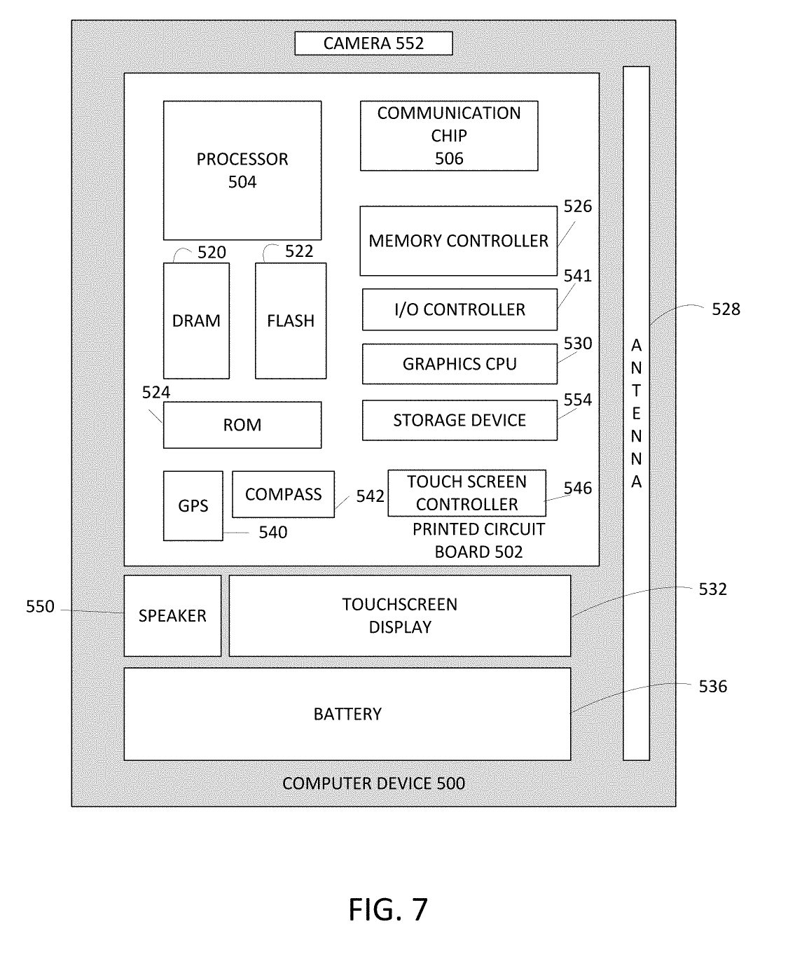

In various embodiments, shopper tracking system 102 may be implemented using dedicated, custom programmed hardware, a general purpose computer device or computer devices running specific software that implements one or more of the components or functionality of shopper tracking system 102, or a combination of both. Examples of such computer devices are detailed herein with reference to FIG. 7. Moreover, a single system 100 may, in some embodiments, include multiple instances of a shopper tracking system 102, such as where a system 100 is deployed across multiple stores 101, and single shopper tracking system 102 is deployed for each store 101. Still other embodiments may have a single shopper tracking system 102 be deployed across multiple stores 101, and yet other embodiments may have multiple shopper tracking systems 102 be deployed in a single store 101, for example where a store 101 may have multiple departments, and it may be desirable to deploy separate shopper tracking systems 102 for various departments.

In some embodiments, shopper tracking system 102 may collect shopping behavior data and may track each of plurality of shoppers' 104a to 104c physical location via a number of sensors. For location tracking, some embodiments may rely upon a unique piece of equipment that each of plurality of shoppers 104a to 104c carries on his or her person, such as a phone 116. In many embodiments, phone 116 may be a smartphone, such as an iPhone or Android phone, effectively a mobile implementation of a computer device as described herein with reference to FIG. 7. Such phones 116 may typically be wireless equipped, such as WiFi-enabled. Shopper tracking system 102 may then employ the wireless characteristics of phone 116, such as WiFi fingerprinting, with the unique WiFi or other wireless characteristics of a given phone 116 identifiable and trackable by access point 114 when it is in communication with phone 116. The precise location of access point 114 may be determined during the implementation of shopper tracking system 102. Using signal strength drop off and depending on the configuration of access point 114, the location of phone 116, and by extension, shopper 104, can be determined and tracked over time with reference to the known location of access point 114. Employing multiple access points 114, each with known locations, may allow for more precise location fixing of shopper 104 by cross referencing data between all access points 114 in range of phone 116, and/or by using well-known triangulation techniques. The positioning of such access points 114 may also take accuracy into consideration. A greater number of access points 114 may allow for easier tracking of each of plurality of shoppers 104a to 104c, and so it may be desirable to deploy multiple access points 114 in a greater density around areas where high shopper traffic is expected.

The precision of determining the physical location of a given shopper of the plurality of shoppers 104a to 104c may be improved by integrating data from sensors inside of phone 116, such as the gyroscopes, magnetometers, and accelerometers found inside most smartphones, which allow the position and movements of phone 116, and by extension, the given shopper, to be determined. This additional data can be combined with wireless characteristics (such as WiFi fingerprinting) to determine the position of the given shopper with sub-meter accuracy. Integrating such sensor information may, in some embodiments, require the installation of an app on phone 116.

Some embodiments may encourage or require installation of an appropriate app on phone 116. Such an app may allow each of the plurality of shoppers 104a to 104c to supply information relevant to their shopping experience voluntarily, such as listing hobbies, interests, personal information (e.g. marital status, ethnicity, age, income, gender, home area, etc.). System 100 may, in various embodiments, pass this information on to RTB system 108, which may integrate it with shopping behavior data for message selection. Furthermore, installation of an app may be useful, or in some embodiments, necessary, to obtain bids from shoppers 104a, 104b, and 104c.

In other embodiments, shopper tracking system 102 may use a radio frequency identification (RFID) tag or similar technology to track a given shopper of the plurality of shoppers 104a to 104c. Such implementations of system 100 may require the given shopper to opt in to being tracked, to obtain the necessary RFID tag. Each of the plurality of shoppers 104a to 104c may be encouraged to opt in via a variety of means, such as the possibility to receive, via system 100, offers that provide personalized deals over shoppers that do not opt in to being tracked by system 100. RFID tags may be scanned via access point 114 where properly equipped, or access point 114 may alternatively be implemented as an RFID scanner, rather than a WiFi or other wireless access point. Furthermore, although RFID tags are described as possible embodiments, still other embodiments may employ other technology now known or later developed that allows for precision tracking of a given shopper in a physical area.

In still other embodiments, tags used with shopper tracking system 102 may be located in other devices or items that are unique to and in physical possession of a given shopper. Examples of such items can include smart devices such as smart watches, chips, or tags that may be incorporated into items such as credit cards or ID badges, or other wearable items. Still other examples may rely upon near-field communication (NFC) technology. Such NFC technology may be present in a variety of personal items, including smartphones, smart watches, digital or electronic credit cards, etc. As with WiFi fingerprinting or other wireless characteristics, RFID, tags, or NFC technology may be used for tracking a given shopper.

It can be seen in FIG. 1 that access point 114 may be in communication with shopper tracker 112, which in some embodiments may serve to aggregate and process the raw data from various sensor means for tracking a given shopper from the plurality of shoppers 104a to 104c. In some embodiments, shopper tracker 112 may be a discrete component that may be implemented in hardware. Other embodiments may omit shopper tracker 112, or incorporate shopper tracker 112 into shopper tracking system 102, either using dedicated hardware, a software module, or a combination of both. It should also be understood that although FIG. 1 only depicts a single access point, this is for illustration purposes only, and a given embodiment of system 100 may include multiple access points 114 that can be geographically dispersed throughout brick and mortar store 101 as needed to ensure the desired physical area is covered. Each access point 114 may feed into either shopper tracker 112 or shopper tracking system 102. Moreover, some embodiments of shopper tracking system 102 may use multiple shopper trackers 112, or have some sensors feed into one or more shopper trackers 112 as well as into shopper tracking system 102 directly.

Some embodiments of shopper tracking system 102 may employ computer vision, including computer vision methods such as facial recognition and/or object recognition to track a given shopper from the plurality of shoppers 104a, 104b and 104c, in addition to or in lieu of a physical device that is unique to and in the physical possession of the given shopper. In such embodiments, the given shopper need not carry a phone 116 or RFID tag; rather, one or more cameras 120 may detect and positively identify shopper 104 based on computer vision, including facial recognition, and then track the position of the given shopper within brick and mortar store 101. Still other embodiments of shopper tracking system 102 may use a combination of the techniques listed herein, such as hybrid of wireless characteristics (such as WiFi signature or fingerprinting) and sensors from phone 116, computer vision such as facial and object recognition via camera(s) 120, and/or RFID tags.

Where an embodiment of shopper tracking system 102 assigns a unique identifier to the given shopper, possibly gathered using one of the foregoing techniques for tracking a unique shopper, this information may be passed on to RTB system 108.

In embodiments, shopper tracking system 102 may also track the behavior of each of plurality of shoppers 104a to 104c to gather shopping behavior data, which may be continuously provided to RTB system 108. Shopping behavior data may be gathered using a variety of sensors, similar to tracking the physical location of a given shopper. In FIG. 1, in some embodiments camera 120 may be employed along with the computer vision techniques referenced above to determine the behavior of each shopper and generate corresponding shopping behavior data, which may then be tagged specifically to each shopper of the plurality of shoppers 104a to 104c. Various embodiments may employ computer vision, including facial recognition techniques to analyze the reaction of a given shopper to various products, e.g. determining emotional responses, and/or may detect other shopper attributes such as ethnicity, gender, age, etc., which can be used to add demographic aspects to the collected shopping behavior data. This additional data may be fed to RTB system 108 in instances where RTB system 108 may factor such demographic information into auctions.

In various embodiments, camera 120 may be used to correspond a particular shopper of the plurality of shoppers 104a to 104c (who may be at least partially identified based on physical location and a known position of camera 120) with a particular good or goods proximate to the shopper. Object detection can allow some embodiments of system 100 to ascertain which goods the particular shopper may be looking at and/or handling, thereby allowing system 100 to generate and report relevant shopping behavior data to RTB system 108.

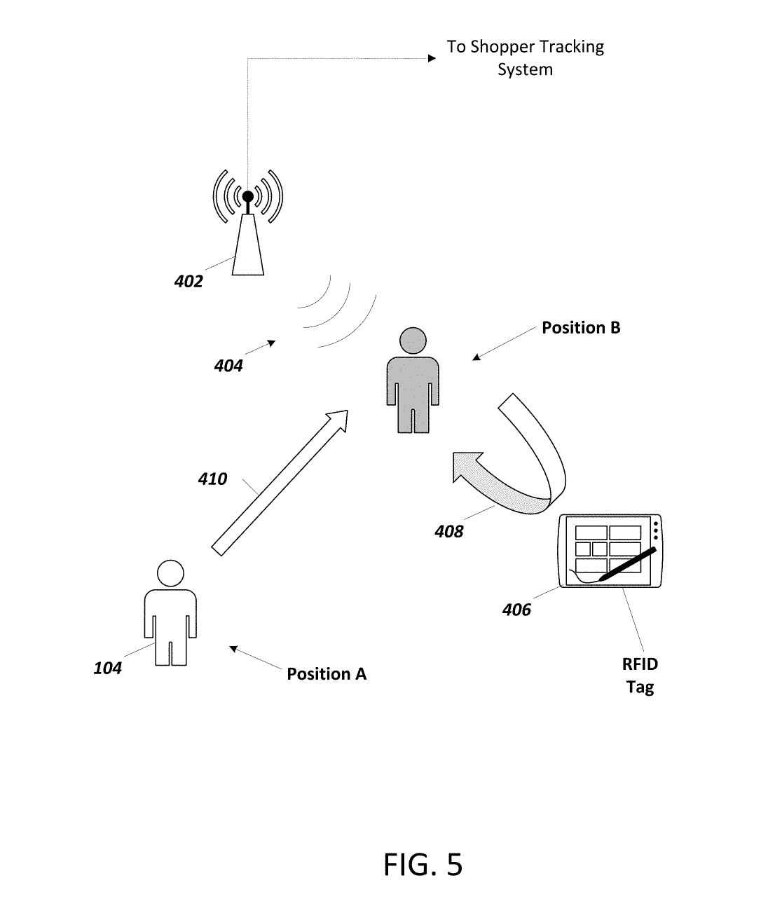

Other embodiments of shopper tracking system 102 may use other sensors and associated techniques to gather shopping behavior data on a given shopper 104 of the plurality of shoppers 104a to 104c, such as RFID signal interference detection 122. FIG. 5 illustrates how RFID signal interference may be used to determine the given shopper's behavior in some embodiments. The given shopper 104 may be in initial position A, proximate to, but not in the path defined between an RFID reader 402 and an RFID tag-equipped item 406. In normal operation, RFID reader 402 may emit a signal 404 that may be received by the RFID tag in item 406. The RFID tag in item 406 may respond 408 with its unique information, which RFID reader 402 in turn may pick up. When shopper 104 moves into position B, in the path defined by RFID reader 402 and item 406, signal 404 as well as response 408 may be substantially blocked, preventing RFID reader 402 from receiving a proper response to signal 404. By detecting this loss of response 408 and/or a possible reflection of signal 404, and correlating with the type of item 406 that is RFID tagged, shopper tracking system 102 may ascertain at least the types of items 406 to which shopper 104 is proximate. Furthermore, where shopper 104 handles a particular item 406, intermittent and/or garbled responses 408 may be received, which may be analyzed in some embodiments to distinguish between shopper 104 actually handling item 406, or simply walking past item 406. Embodiments where RFID signal interference may be combined with computer vision such as facial and object recognition as well as physical location tracking may yield more accurate shopping behavior data, such as distinguishing between a shopper 104 who is actively examining an item 406, or is facing away and just happens to be proximate to item 406.

As with shopper tracker 112, in some embodiments, camera 120 and RFID signal interference detector 122 may feed into a shopping behavior data collector 118 for aggregation and/or preprocessing of sensor data. Depending on the embodiment, shopping behavior data collector 118 may be implemented as a discrete hardware component, may be implemented as one or more software modules on shopper tracking system 102, may be implemented as a combination of both hardware and software, or may be omitted entirely, where the functionality of shopping behavior data collector 118 may be handled by other modules or components of shopper tracking system 102.

Although FIG. 1 depicts a single camera 120 and RFID interference detector 122, it should be understood that this is for example purposes only. Embodiments of system 100 may be equipped with multiple cameras 120 and/or RFID interference detectors 122, depending upon the particular needs of a given implementation.

In various embodiments, the shopping behavior data for a given shopper may be stored and retrieved within shopper tracking system 102 each time the given shopper enters within brick and mortar store 101. Such data may be tagged with information identifying the shopping behavior data with a particularly identified shopper from the plurality of shoppers 104a to 104c. Other embodiments may store shopping behavior data for the given shopper that may be collected from various stores 101 that may be unrelated to each other. Such embodiments may determine that the given shopper is looking for a particular item or type of item, perhaps searching for a particular price or configuration, which may be valuable information to feed to RTB system 108. In embodiments of system 100 that store and retrieve shopping behavior data across multiple visits to the same store 101 or to different stores 101 owned/operated by different parties, RTB system 108 may have a greater amount of data to draw from in selecting messages and associated offered products to participate in a given real-time auction.

Some embodiments may either not store historic shopping behavior data, or may instead rely upon RTB system 108 to store historic shopping behavior data. Where RTB system 108 is relied upon to store shopping behavior data, shopper tracking system 102 may simply send RTB system 108 an identifier unique to a given shopper of the plurality of shoppers 104a, 104b and 104c along with the shopping behavior data, which RTB system 108 may then use to reference stored historic shopping behavior data. Depending upon the RTB system 108 employed, RTB system 108 may automatically track and aggregate shopping behavior data from multiple visits to various unrelated stores 101 that are derived from a single identified shopper.

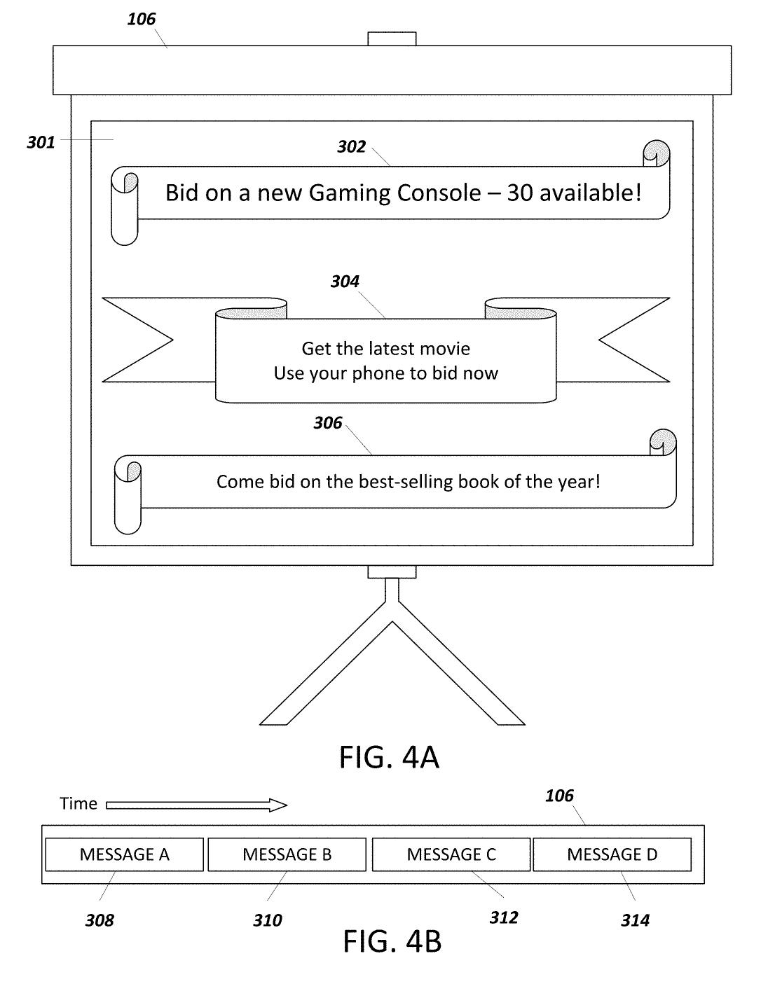

Referring to FIG. 4A, electronic sign 106 may include a display area 301 where various messages 302, 304, 306 received from real time bidding system 108 may be displayed. Display area 301 may be implemented using any display technology now known or later developed that is capable of displaying arbitrary content. Such technologies may include CRT, LCD, LED, OLED, DLP, projection, or any other similar display type. Electronic sign 106 may be implemented as a single unit, similar to an “all in one” type computer, or with multiple units. In single-unit implementations, equipment for receiving the messages 302, 304, 306 and driving display area 301, as well as display area 301, may be housed in a single physical package. Conversely, multiple unit implementations may place display area 301 into a single package, such as a computer monitor, with equipment for receiving messages and driving display area 301 placed into a separate package, such as a computer or CPU box. Still other multiple unit embodiments may implement display area 301 as a projector screen and corresponding projector, with equipment for receiving messages and driving display area 301 either integrated into the projector unit, or housed in a separate box.

FIGS. 4A and 4B also depict one possible arrangement of slots for messages from real time bidding system 108. In embodiments, electronic sign 106 may support either physical message slots, time-based message slots, or a combination of both. FIG. 4A may show a possible embodiment of physical message slots. Display area 301 can be divided into physical areas, with each area containing a message and thus forming a physical message slot. As depicted in FIG. 4A, messages 302, 304, and 306 may each occupy one physical message slot, each differ in content, and each occupy different physical areas of display area 301. Each message slot may present a message with a different offered product, thus enabling a single electronic sign 106 to be used for multiple purposes, as well as with multiple possible pluralities of shoppers 104a to 104c.

In embodiments of system 100, the displayed messages may offer various products to the plurality of shoppers 104a, 104b and 104c, which each of the plurality of shoppers 104a to 104c may bid upon. These messages may be selected by RTB system 108 on the basis of the supplied shopping behavior data relating to the plurality of shoppers 104a to 104c. More specifically, RTB system 108 may select an appropriate message that may offer one or more products for sale on the basis of shopping behaviors that each of the plurality of shoppers 104, 104b, and 104c may share in common. The offered products may be available from multiple sellers 105a to 105c. Further, it will be understood that there may be multiple pluralities of sellers 105a to 105c with system 100 offering different products, and these multiple pluralities as well may overlap to varying extents where a given seller may offer multiple products that overlap to some extent with another given seller. By supplying messages to electronic sign 106 offering products that may appeal to each of the plurality of shoppers 104a to 104c, multiple quantities of the offered products may be sold.

Where a store 101 implements system 100, system 100 may be configured to interface with the point of sale (POS) systems of the operator of store 101. System 100 may thus allow each winning bidder of the plurality of shoppers 104a to 104c to complete their winning transaction using store's 101 POS systems. Alternatively or additional, system 100 may enable each winning bidder of plurality of shoppers 104a, 104b and 104c to complete the transaction via a smartphone, web browser, or some other suitable mechanism. Some further embodiments of system 100 may do this automatically, completing the transaction upon determining the winning bidders from a double auction on a given offered product. Furthermore, while a smartphone in the possession of a shopper is one possible embodiment for supplying bids to system 100, any mechanism by which a shopper may provide bids may be used with system 100. For example, some embodiments of system 100 may have a dedicated hardware device or in-store 101 kiosk for receiving bids.

Although FIG. 4A depicts the message slots oriented in a roughly horizontal fashion, other embodiments may provide slots that are oriented substantially vertically, a combination of both horizontal or vertical areas, a series of squares, rectangles or other polygons, or some combination of any of the foregoing. Each physical message slot need not be of identical size; some embodiments may allow physical message slots of varying sizes and shapes, including, in some embodiments, a message that occupies the entirety of display area 301, limiting electronic sign 106 to the display of a single message. The particular physical message slot configuration may depend on such factors as the number of shoppers proximate to electronic sign, the content of the supplied messages, shopper interest, number of shoppers of a given plurality of shoppers 104a, 104b and 140c, number of sellers of a given plurality of sellers 105a, 105b and 105c, total quantity of a given offered product, estimated price range of a given offered products, the length of time the message has been displayed in the message slot, among other factors. Moreover, the configuration of the various physical message slots may be dynamic in some embodiments, with the number, shape, and size of the various physical message slots changing over time, including a physical message slot being reconfigured to different dimensions over time while retaining its message.

FIG. 4B depicts time-based message slots. Such slots may occupy a single physical message slot on electronic sign 106, but change messages over time. RTB system 108 may configure specific amounts of time designated to each physical message slot, which comprises a time-based message slot. Once the designated amount of time elapses, the time-based message slot may be released to accept a new message. The length of time for each time-based message slot may be determined by any number of methods, e.g. a fixed predetermined time amount, or a flexible time amount. A flexible time amount can be based upon a variety of criteria, including shopper interest, number of shoppers of a given plurality of shoppers 104a, 104b and 140c, number of sellers of a given plurality of sellers 105a, 105b and 105c, total quantity of a given offered product, estimated price range of a given offered products, message content (messages with more information may need a longer time slot), etc., or some combination of these or other factors. Time slot lengths may be determined by the operator of system 100, the operator of RTB system 108 (if different from the operator of system 100), the manufacturer of electronic sign 106, or any other appropriate party, depending upon the particulars of a given embodiment.

Where electronic sign 106 is configured to present a single message, that is, the entirety of display area 301 is devoted to a single physical message slot, time-based message slots may be employed to allow electronic sign 106 to present messages to different shoppers 104. It should also be apparent that in some embodiments time-based message slots can be used in conjunction with one or more physical message slots. In such embodiments, multiple messages in different physical message slots may be displayed simultaneously, with time-based slots used for one or more of the different physical message slots.

The use of message slots, both physical and time-based, may allow system 100 to accommodate tracking of multiple pluralities of shoppers 104a to 104c, as well as providing messages offering multiple products. Where multiple products are offered, the products may differ from message to message or, in other embodiments, identical products may be offered from different auctions, possibly from various pluralities of shoppers 105a to 105c and to different pluralities of shoppers 104a to 104c. In some embodiments, system 100 may cause electronic sign 106 to reconfigure with multiple physical message slots corresponding to multiple offered products and/or multiple pluralities of sellers 105a to 105c. Other embodiments may employ time-based message slots, cycling through messages directed to each of the various pluralities of shoppers 104a to 104c and/or multiple offered products, while other embodiments may combine both physical and time-based message slots, as described above.

Configuration of a given electronic sign 106 may be handled by shopper tracking system 102, which may, in some embodiments, act as an intermediary for delivering messages from RTB system 108 to electronic sign 106. In such embodiments, shopper tracking system 102 may determine the best way to manage electronic sign 106, such as configuration of various physical message slots, and when/where to employ time-based message slots. Other embodiments may push such configuration onto electronic sign 106, which may locally determine the best way to present multiple messages. In such embodiments, each message may include information such as a desired size (where physical message slots are employed) and/or desired display time (where time-based message slots are employed). Still other embodiments may allow RTB system 108 to determine the configuration of electronic sign 106 directly.

As described above, in embodiments shopper tracking system 102 may supply RTB system 108 a variety of information in shopping behavior data. Such data may allow RTB system 108 to conduct separate auctions for message slots for multiple pluralities of shoppers 104a to 104c and/or to customize particular messages for a given plurality of shoppers. Where system 100 is implemented with multiple electronic signs 106, such information may also include the particular electronic sign 106 to which a given plurality of shoppers 104a to 104c is proximate, or which may be determined by RTB system 108, to ensure the plurality of shoppers 104a to 104c sees messages designated for them. As illustrated by FIG. 4A, in some embodiments where multiple messages are displayed on electronic sign 106, RTB system 108 may be supplied with information about the physical configuration of electronic sign 106 to determine the quantity of messages. In other embodiments, RTB system 108 may simply be provided with the overall parameters of electronic sign 106 (e.g. the size of display area 301 and/or message time length), with RTB system 108 using such information to determine quantity.

RTB system 108 may be operated independently from shopper tracking system 102, or it may be operated by a single entity as part of an embodiment of system 100. Where RTB system 108 is operated independently, it may be in the form of an established RTB system that is in use with websites, which can be adapted to service system 100. Where RTB system 108 is also employed with websites, in some embodiments RTB system 108 may be able to correlate and integrate shopping behavior data obtained from the online activities of each of the plurality of shoppers 104a to 104c with the shopping behavior data obtained from store 101. Thus, RTB system 108 may utilize the online shopping behavior data to personalize offers for at least a subset of the plurality of shoppers 104a to 104c further via electronic sign 106. Other embodiments may employ RTB system 108 to integrate shopping behavior data obtained from multiple instances of a store 101, such as where an operator of a single system 100 operates multiple stores 101, as in the case of chain stores. RTB system 108 may receive shopping behavior data from across all or some of the multiple stores 101, and in some embodiments may receive shopping behavior data for a single shopper's visits to multiple stores 101. In some embodiments, RTB system 108 may additionally integrate online shopping behavior data, which may include shopping behavior data obtained from a website also operated by the operator of store 101 or multiple stores 101. In still other embodiments, system 100 may use an existing RTB system 108 (such as the RTB systems in place from Google) to conduct auctions and obtain messages, with system 100 then handling management and placement of messages on electronic signs 106.

In still other embodiments, RTB system 108 may service multiple implementations of system 100, where each implementation of system 100 may be owned/operated by different, unrelated entities. For example, a first embodiment of system 100 may be operated by a first party who operates a first store 101, and a second embodiment of system 100 may be operated by a second party who operates a second store 101, with the first party and second party being unrelated. Each of the first embodiment and second embodiment of system 100 may interface with a single RTB system 108, which may supply content for a first set of electronic signs 106 associated with the first embodiment of system 100, and a second set of electronic signs 106 associated with the second embodiment of system 100. It should be appreciated that this is merely an example, and a given RTB system 108 may be configured to interact, potentially including both receiving disparate and unrelated shopping behaviors as well as supplying unrelated messages, with any number of different systems 100.

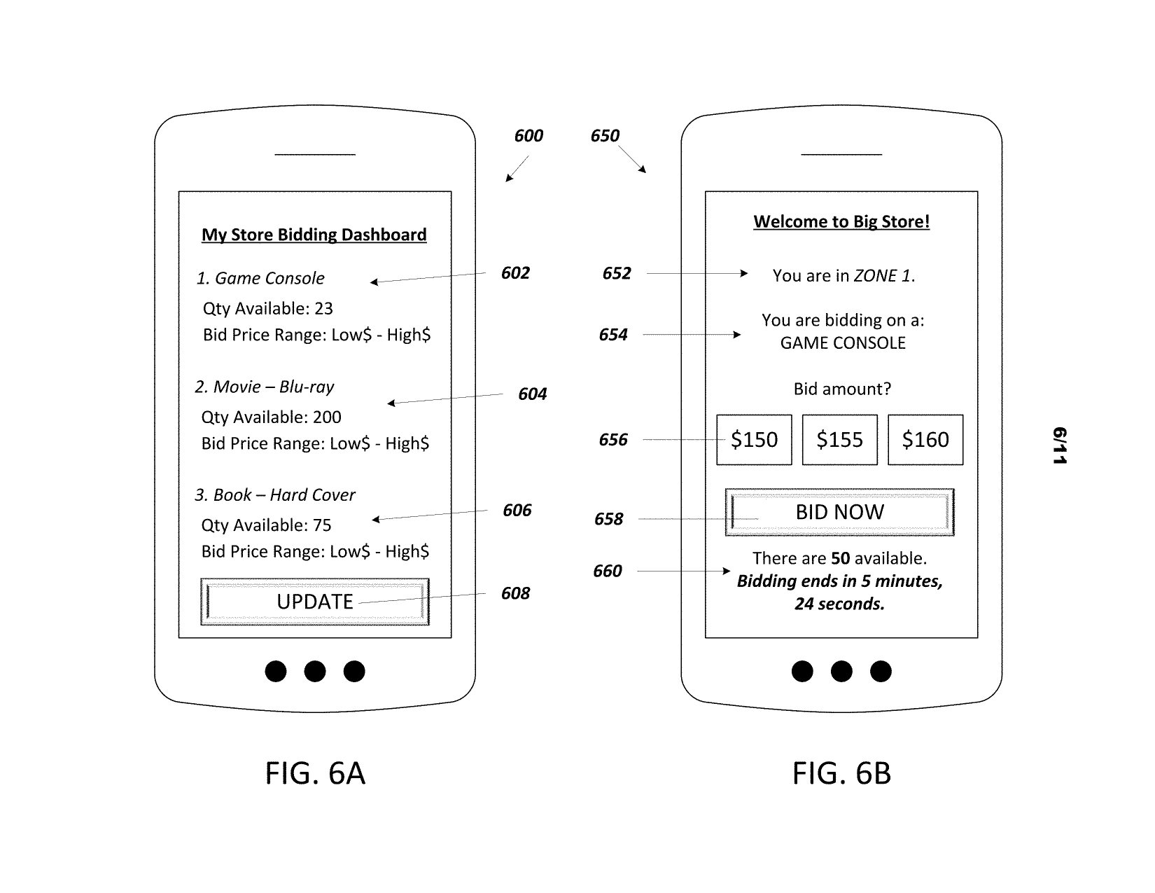

FIG. 6A depicts one possible embodiment of a user interface 600 for sellers 105. User interface 600 may present a seller 105 with a list of products that seller 105 is offering for sale. Each listing 602, 604 and 606 may include parameters such as the name of the product, the quantity of the product available, and seller 105's bid price range, which is the range which seller 105 bids to sell a particular product. For example, seller 105 may specify a range of acceptable sales prices, may bid a single price, or may bid a “no lower than” or “floor” price, where seller 105 signals they are willing to sell a product at any price down to the floor price. Each of these parameters may, in some embodiments, be modified. Upon modification, seller 105 may signal RTB system 108 to update 608 the parameters, which are used as input for the double auction. User interface 600 may offer other options to a seller 105, such as the ability to add or delete items being offered, as well as specify market demographics for consideration by RTB system 108 in the selection of a plurality of shoppers 104a to 104c as well as selection of an appropriate message for display to initiate an auction.

FIG. 6B likewise depicts a possible embodiment of a user interface 650 for buyers; it will be understood that buyers are shoppers 104a to 104c. User interface 650 may include a location indicator 652 which may signal the buyer where or in what department of the store 101 they are located or are placing a bid. Product indicator 654 may indicate the product, offered via a message on a proximate electronic sign 106, upon which the buyer is bidding. Several buttons 656 are presented to allow the buyer to bid a desired amount. While buttons 656 are depicted offering preset bid amounts, user interface 650 could also or alternatively allow the buyer to enter any ad hoc amount, possibly subject only to any auction restrictions (e.g. reserve amount, denomination increment, minimum bid increase, etc.). The buyer, in the case of user interface 650 as depicted, may select an amount by tapping on the appropriate button 656 and then submit a bid by tapping the “BID NOW” button 658. User interface 650 also may include additional information about a particular item auction, such as the total number of available items as well as the end of auction time to signal when bidding may close.

User interfaces 600 and 650 are example embodiments of a possible user interface, and are shown implemented on a smartphone or similar touch-screen based device. Other embodiments may be implemented on a computer screen, e.g. in a web browser or via a dedicated application, or using a dedicated hardware device, or a combination of dedicated hardware and software. Furthermore, the particular elements depicted in user interfaces 600 and 650 likewise are mere examples. Other embodiments of user interfaces 600 and/or 650 may arrange elements in a different fashion, omit or add elements, and/or offer different functionality depending upon the needs of a given embodiment of system 100.

Furthermore, where the device used to provide user interface 650 is a smartphone in the possession of a shopper, that same smartphone may be used in conjunction with shopper tracking system 102 as described above. In other embodiments, the smartphone may not be used with shopper tracking system 102, and may merely be used by the shopper to supply bids.

If a shopper 104 successfully bids for a product, shopper 104 may be presented with the option to complete the purchase via user interface 650. In other embodiments, the purchase may automatically complete upon shopper 104 submitting a winning bid. In such embodiments, submitting a bid amounts to an agreement to purchase the bid-upon item should the bid successful. Some embodiments of system 100 may require a shopper 104 to provide payment information prior to being allowed to place a bid, so that upon winning, the purchase transaction may be automatically completed, with shopper 104 being notified of the win.

Some embodiments may provide a winning shopper 104 with the opportunity to obtain and pay for an item within store 101, such as with a cashier at a cash register or via a self-checkout kiosk, for example. Other embodiments may not only allow the winning shopper 104 to pay for a won item, but also immediately pick up the won item from store 101.

FIG. 7 illustrates an example computer device 500 that may employ the apparatuses and/or methods described herein (e.g., the shopper tracking system 102, the electronic sign 106, the RTB system 108, and/or the phone 116), in accordance with various embodiments. As shown, computer device 500 may include a number of components, such as one or more processor(s) 504 (one shown) and at least one communication chip 506. In various embodiments, the one or more processor(s) 504 each may include one or more processor cores. In various embodiments, the one or more processor(s) 504 may include hardware accelerators to complement the one or more processor cores. In various embodiments, the at least one communication chip 506 may be physically and electrically coupled to the one or more processor(s) 504. In further implementations, the communication chip 506 may be part of the one or more processor(s) 504. In various embodiments, computer device 500 may include printed circuit board (PCB) 502. For these embodiments, the one or more processor(s) 504 and communication chip 506 may be disposed thereon. In alternate embodiments, the various components may be coupled without the employment of PCB 502.

Depending on its applications, computer device 500 may include other components that may be physically and electrically coupled to the PCB 502. These other components may include, but are not limited to, memory controller 526, volatile memory (e.g., dynamic random access memory (DRAM) 520), non-volatile memory such as read only memory (ROM) 524, flash memory 522, storage device 554 (e.g., a hard-disk drive (HDD)), an I/O controller 541, a digital signal processor (not shown), a crypto processor (not shown), a graphics processor 530, one or more antennae 528, a display (not shown but could include at least the display area 301 of electronic sign 106), a touch screen display 532, a touch screen controller 546, a battery 536, an audio codec (not shown), a video codec (not shown), a global positioning system (GPS) device 540, a compass 542, an accelerometer (not shown), a gyroscope (not shown), a speaker 550, a camera 552, and a mass storage device (such as hard disk drive, a solid state drive, compact disk (CD), digital versatile disk (DVD)) (not shown), and so forth.

In some embodiments, the one or more processor(s) 504, flash memory 522, and/or storage device 554 may include associated firmware (not shown) storing programming instructions configured to enable computer device 500, in response to execution of the programming instructions by one or more processor(s) 504, to practice all or selected aspects of the shopper tracking and/or targeted messaging methods associated with real-time double bidding described herein. In various embodiments, these aspects may additionally or alternatively be implemented using hardware separate from the one or more processor(s) 504, flash memory 522, or storage device 554.

The communication chips 506 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WMAX), Bluetooth, derivatives thereof, as well as any other wireless protocols that are designated as 3G, 4G, 5G, and beyond. The computer device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, Ev-DO, and others.

In various implementations, the computer device 500 may be a laptop, a netbook, a notebook, an ultrabook, a smartphone, a computer tablet, a personal digital assistant (PDA), a desktop computer, or a server. In further implementations, the computer device 500 may be any other electronic device that processes data.

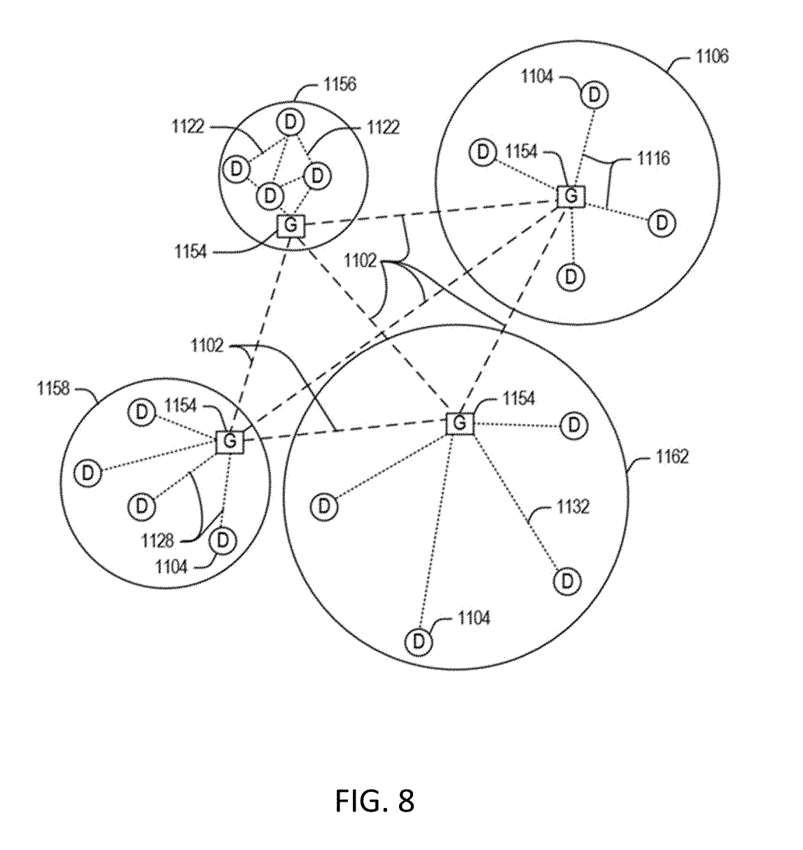

FIG. 8 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

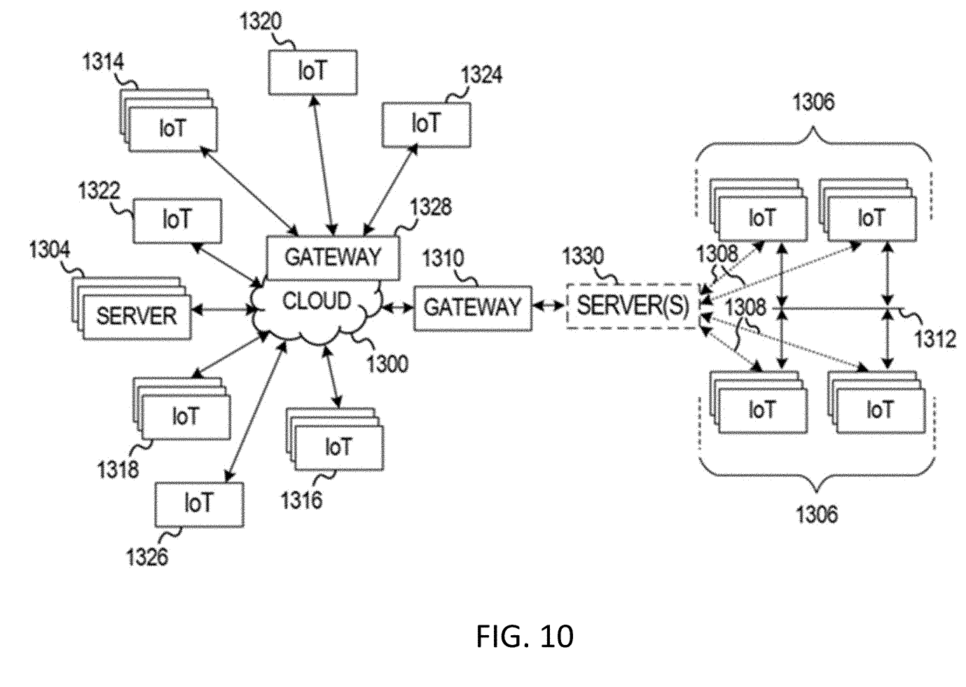

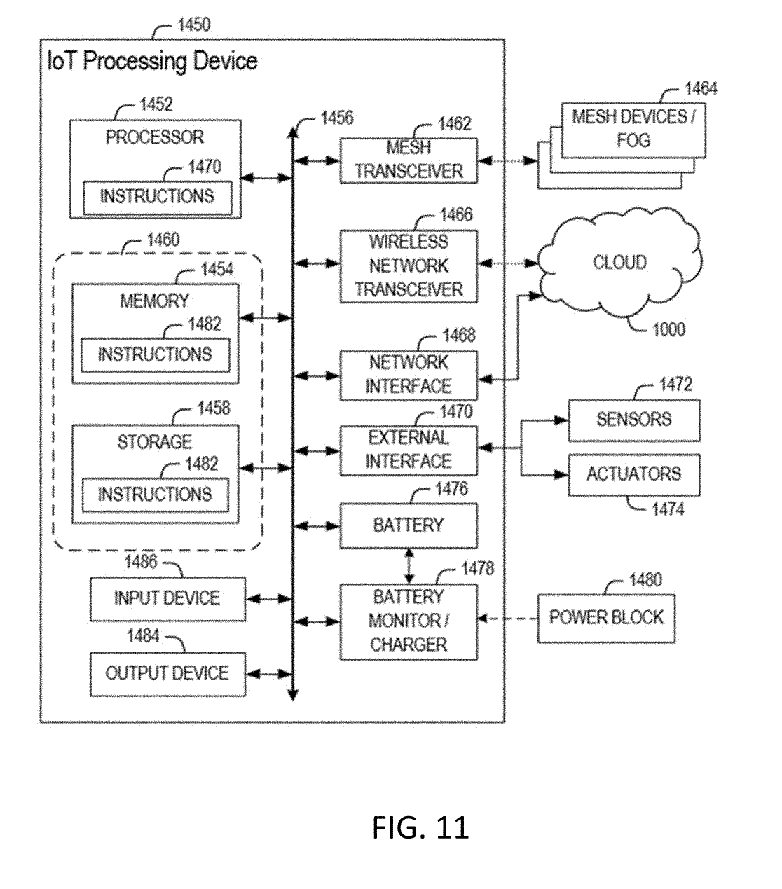

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 10 and 11, present a number of new challenges in a heterogeneous network of connectivity comprising a combination of wired and wireless technologies.

FIG. 8 specifically provides a simplified drawing of a domain topology that may be used for a number of internet-of-things (IoT) networks comprising IoT devices 1104, with the IoT networks 1156, 1158, 1160, 1162, coupled through backbone links 1102 to respective gateways 1154. For example, a number of IoT devices 1104 may communicate with a gateway 1154, and with each other through the gateway 1154. To simplify the drawing, not every IoT device 1104, or communications link (e.g., link 1116, 1122, 1128, or 1132) is labeled. The backbone links 1102 may include any number of wired or wireless technologies, including optical networks, and may be part of a local area network (LAN), a wide area network (WAN), or the Internet. Additionally, such communication links facilitate optical signal paths among both IoT devices 1104 and gateways 1154, including the use of MUXing/deMUXing components that facilitate interconnection of the various devices.

The network topology may include any number of types of IoT networks, such as a mesh network provided with the network 1156 using Bluetooth low energy (BLE) links 1122. Other types of IoT networks that may be present include a wireless local area network (WLAN) network 1158 used to communicate with IoT devices 1104 through IEEE 802.11 (W-Fi®) links 1128, a cellular network 1160 used to communicate with IoT devices 1104 through an LTE/LTE-A (4G) or 5G cellular network, and a low-power wide area (LPWA) network 1162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 1104, such as over the backbone links 1102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 1156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1158, for instance, may use systems that perform standards conversion to provide multi-standard connectivity, enabling IoT devices 1104 using different protocols to communicate. Further systems may provide seamless interconnectivity across a multi-standard infrastructure comprising visible Internet resources and hidden Internet resources.

Communications in the cellular network 1160, for instance, may be enhanced by systems that offload data, extend communications to more remote devices, or both. The LPWA network 1162 may include systems that perform non-Internet protocol (IP) to IP interconnections, addressing, and routing. Further, each of the IoT devices 1104 may include the appropriate transceiver for wide area communications with that device. Further, each IoT device 1104 may include other transceivers for communications using additional protocols and frequencies. This is discussed further with respect to the communication environment and hardware of an IoT processing device depicted in FIGS. 10 and 11.

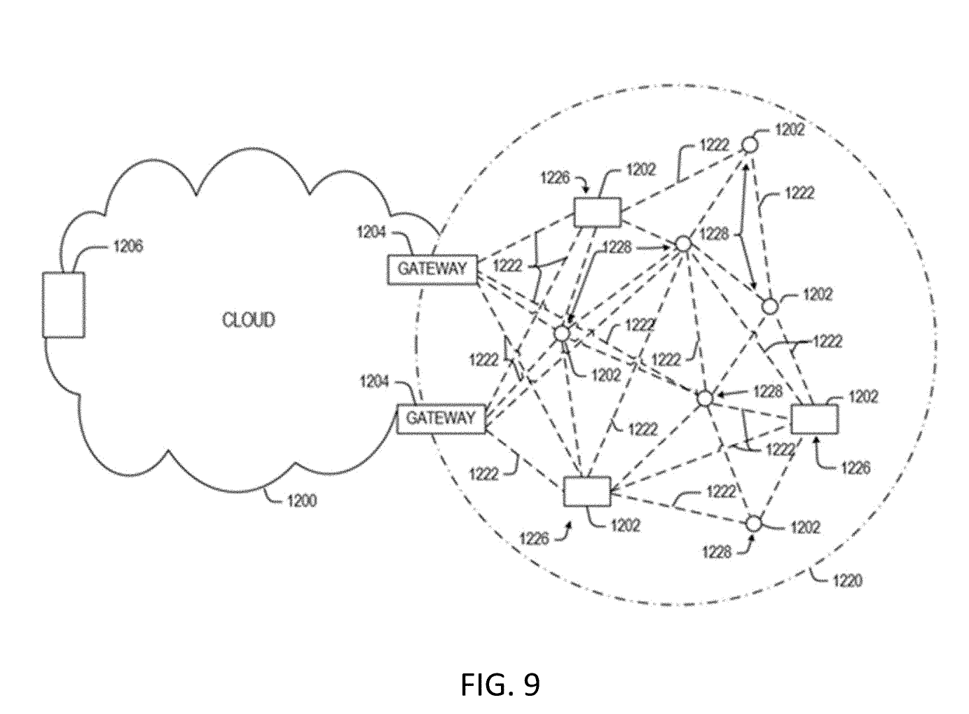

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 9 below.

FIG. 9 illustrates a cloud computing network in communication with a mesh network of IoT devices (devices 1202) operating as a fog device at the edge of the cloud computing network. The mesh network of IoT devices may be termed a fog 1220, operating at the edge of the cloud 1200. To simplify the diagram, not every IoT device 1202 is labeled.

The fog 1220 may be considered to be a massively interconnected network wherein a number of IoT devices 1202 are in communications with each other, for example, by radio links 1222. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1202 are shown in this example, gateways 1204, data aggregators 1226, and sensors 1228, although any combinations of IoT devices 1202 and functionality may be used. The gateways 1204 may be edge devices that provide communications between the cloud 1200 and the fog 1220, and may also provide the backend process function for data obtained from sensors 1228, such as motion data, flow data, temperature data, and the like. The data aggregators 1226 may collect data from any number of the sensors 1228, and perform the back end processing function for the analysis. The results, raw data, or both may be passed along to the cloud 1200 through the gateways 1204. The sensors 1228 may be full IoT devices 1202, for example, capable of both collecting data and processing the data. In some cases, the sensors 1228 may be more limited in functionality, for example, collecting the data and allowing the data aggregators 1226 or gateways 1204 to process the data.

Communications from any IoT device 1202 may be passed along a convenient path (e.g., a most convenient path) between any of the IoT devices 1202 to reach the gateways 1204. In these networks, the number of interconnections provide substantial redundancy, allowing communications to be maintained, even with the loss of a number of IoT devices 1202. Further, the use of a mesh network may allow IoT devices 1202 that are very low power or located at a distance from infrastructure to be used, as the range to connect to another IoT device 1202 may be much less than the range to connect to the gateways 1204.

The fog 1220 provided from these IoT devices 1202 may be presented to devices in the cloud 1200, such as a server 1206, as a single device located at the edge of the cloud 1200, e.g., a fog device. In this example, the alerts coming from the fog device may be sent without being identified as coming from a specific IoT device 1202 within the fog 1220. In this fashion, the fog 1220 may be considered a distributed platform that provides computing and storage resources to perform processing or data-intensive tasks such as data analytics, data aggregation, and machine-learning, among others.

In some examples, the IoT devices 1202 may be configured using an imperative programming style, e.g., with each IoT device 1202 having a specific function and communication partners. However, the IoT devices 1202 forming the fog device may be configured in a declarative programming style, allowing the IoT devices 1202 to reconfigure their operations and communications, such as to determine needed resources in response to conditions, queries, and device failures. As an example, a query from a user located at a server 1206 about the operations of a subset of equipment monitored by the IoT devices 1202 may result in the fog 1220 device selecting the IoT devices 1202, such as particular sensors 1228, needed to answer the query. The data from these sensors 1228 may then be aggregated and analyzed by any combination of the sensors 1228, data aggregators 1226, or gateways 1204, before being sent on by the fog 1220 device to the server 1206 to answer the query. In this example, IoT devices 1202 in the fog 1220 may select the sensors 1228 used based on the query, such as adding data from flow sensors or temperature sensors. Further, if some of the IoT devices 1202 are not operational, other IoT devices 1202 in the fog 1220 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 10 illustrates a drawing of a cloud computing network, or cloud 1300, in communication with a number of Internet of Things (IoT) devices. The cloud 1300 may represent the Internet, or may be a local area network (LAN), or a wide area network (WAN), such as a proprietary network for a company. The IoT devices may include any number of different types of devices, grouped in various combinations. For example, a traffic control group 1306 may include IoT devices along streets in a city. These IoT devices may include stoplights, traffic flow monitors, cameras, weather sensors, and the like. The traffic control group 1306, or other subgroups, may be in communication with the cloud 1300 through wired or wireless links 1308, such as LPWA links, optical links, and the like. Further, a wired or wireless sub-network 1312 may allow the IoT devices to communicate with each other, such as through a local area network, a wireless local area network, and the like. The IoT devices may use another device, such as a gateway 1310 or 1328 to communicate with remote locations such as the cloud 1300; the IoT devices may also use one or more servers 1330 to facilitate communication with the cloud 1300 or with the gateway 1310. For example, the one or more servers 1330 may operate as an intermediate network node to support a local edge cloud or fog implementation among a local area network. Further, the gateway 1328 that is depicted may operate in a cloud-to-gateway-to-many edge devices configuration, such as with the various IoT devices 1314, 1320, 1324 being constrained or dynamic to an assignment and use of resources in the cloud 1300.

Other example groups of IoT devices may include remote weather stations 1314, local information terminals 1316, alarm systems 1318, automated teller machines 1320, alarm panels 1322, or moving vehicles, such as emergency vehicles 1324 or other vehicles 1326, among many others. Each of these IoT devices may be in communication with other IoT devices, with FIG. 9), or a combination therein. The groups of IoT devices may be deployed in various residential, commercial, and industrial settings (including in both private or public environments).

As can be seen from FIG. 10, a large number of IoT devices may be communicating through the cloud 1300. This may allow different IoT devices to request or provide information to other devices autonomously. For example, a group of IoT devices (e.g., the traffic control group 1306) may request a current weather forecast from a group of remote weather stations 1314, which may provide the forecast without human intervention. Further, an emergency vehicle 1324 may be alerted by an automated teller machine 1320 that a burglary is in progress. As the emergency vehicle 1324 proceeds towards the automated teller machine 1320, it may access the traffic control group 1306 to request clearance to the location, for example, by lights turning red to block cross traffic at an intersection in sufficient time for the emergency vehicle 1324 to have unimpeded access to the intersection.

Clusters of IoT devices, such as the remote weather stations 1314 or the traffic control group 1306, may be equipped to communicate with other IoT devices as well as with the cloud 1300. This may allow the IoT devices to form an ad-hoc network between the devices, allowing them to function as a single device, which may be termed a fog device or system (e.g., as described above with reference to FIG. 9).

FIG. 11 is a block diagram of an example of components that may be present in an IoT device 1450 for implementing the techniques described herein. The IoT device 1450 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1450, or as components otherwise incorporated within a chassis of a larger system. Additionally, the block diagram of FIG. 11 is intended to depict a high-level view of components of the IoT device 1450. However, some of the components shown may be omitted, additional components may be present, and different arrangement of the components shown may occur in other implementations.

The IoT device 1450 may include a processor 1452, which may be a microprocessor, a multi-core processor, a multithreaded processor, an ultra-low voltage processor, an embedded processor, or other known processing element. The processor 1452 may be a part of a system on a chip (SoC) in which the processor 1452 and other components are formed into a single integrated circuit, or a single package, such as the Edison™ or Galileo™ SoC boards from Intel. As an example, the processor 1452 may include an Intel® Architecture Core™ based processor, such as a Quark™, an Atom™ an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1452 may communicate with a system memory 1454 over an interconnect 1456 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1458 may also couple to the processor 1452 via the interconnect 1456. In an example the storage 1458 may be implemented via a solid state disk drive (SSDD). Other devices that may be used for the storage 1458 include flash memory cards, such as SD cards, microSD cards, xD picture cards, and the like, and USB flash drives. In low power implementations, the storage 1458 may be on-die memory or registers associated with the processor 1452. However, in some examples, the storage 1458 may be implemented using a micro hard disk drive (HDD). Further, any number of new technologies may be used for the storage 1458 in addition to, or instead of, the technologies described, such resistance change memories, phase change memories, holographic memories, or chemical memories, among others.

The components may communicate over the interconnect 1456. The interconnect 1456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1456 may be a proprietary bus, for example, used in a SoC based system. Other bus systems may be included, such as an 120 interface, an SPI interface, point to point interfaces, and a power bus, among others.

The interconnect 1456 may couple the processor 1452 to a mesh transceiver 1462, for communications with other mesh devices 1464. The mesh transceiver 1462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1464. For example, a WLAN unit may be used to implement W-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1462 may communicate using multiple standards or radios for communications at different range. For example, the IoT device 1450 may communicate with close devices, e.g., within about 10 meters, using a local transceiver based on BLE, or another low power radio, to save power. More distant mesh devices 1464, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1466 may be included to communicate with devices or services in the cloud 1400 via local or wide area network protocols. The wireless network transceiver 1466 may be a LPWA transceiver that follows the IEEE 802.15.4, or IEEE 802.15.4g standards, among others. The IoT device 1450 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1462 and wireless network transceiver 1466, as described herein. For example, the radio transceivers 1462 and 1466 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1462 and 1466 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1466, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1468 may be included to provide a wired communication to the cloud 1400 or to other devices, such as the mesh devices 1464. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1468 may be included to allow connect to a second network, for example, a NIC 1468 providing communications to the cloud over Ethernet, and a second NIC 1468 providing communications to other devices over another type of network.

The interconnect 1456 may couple the processor 1452 to an external interface 1470 that is used to connect external devices or subsystems. The external devices may include sensors 1472, such as accelerometers, level sensors, flow sensors, optical light sensors, camera sensors, temperature sensors, a global positioning system (GPS) sensors, pressure sensors, barometric pressure sensors, and the like. The external interface 1470 further may be used to connect the IoT device 1450 to actuators 1474, such as power switches, valve actuators, an audible sound generator, a visual warning device, and the like.

In some optional examples, various input/output (I/O) devices may be present within, or connected to, the IoT device 1450. For example, a display or other output device 1484 may be included to show information, such as sensor readings or actuator position. An input device 1086, such as a touch screen or keypad may be included to accept input. An output device 1484 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1450.

A battery 1476 may power the IoT device 1450, although in examples in which the IoT device 1450 is mounted in a fixed location, it may have a power supply coupled to an electrical grid. The battery 1476 may be a lithium ion battery, or a metal-air battery, such as a zinc-air battery, an aluminum-air battery, a lithium-air battery, and the like.

A battery monitor/charger 1478 may be included in the IoT device 1450 to track the state of charge (SoCh) of the battery 1476. The battery monitor/charger 1478 may be used to monitor other parameters of the battery 1476 to provide failure predictions, such as the state of health (SoH) and the state of function (SoF) of the battery 1476. The battery monitor/charger 1478 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1478 may communicate the information on the battery 1476 to the processor 1452 over the interconnect 1456. The battery monitor/charger 1478 may also include an analog-to-digital (ADC) convertor that allows the processor 1452 to directly monitor the voltage of the battery 1476 or the current flow from the battery 1476. The battery parameters may be used to determine actions that the IoT device 1450 may perform, such as transmission frequency, mesh network operation, sensing frequency, and the like.

A power block 1480, or other power supply coupled to a grid, may be coupled with the battery monitor/charger 1478 to charge the battery 1476. In some examples, the power block 1480 may be replaced with a wireless power receiver to obtain the power wirelessly, for example, through a loop antenna in the IoT device 1450. A wireless battery charging circuit, such as an LTC4020 chip from Linear Technologies of Milpitas, Calif., among others, may be included in the battery monitor/charger 1478. The specific charging circuits chosen depend on the size of the battery 1476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1458 may include instructions 1482 in the form of software, firmware, or hardware commands to implement the techniques described herein. Although such instructions 1482 are shown as code blocks included in the memory 1454 and the storage 1458, it may be understood that any of the code blocks may be replaced with hardwired circuits, for example, built into an application specific integrated circuit (ASIC).

In an example, the instructions 1482 provided via the memory 1454, the storage 1458, or the processor 1452 may be embodied as a non-transitory, machine readable medium 1460 including code to direct the processor 1452 to perform electronic operations in the IoT device 1450. The processor 1452 may access the non-transitory, machine readable medium 1460 over the interconnect 1456. For instance, the non-transitory, machine readable medium 1460 may be embodied by devices described for the storage 1458 of FIG. 11 or may include specific storage units such as optical disks, flash drives, or any number of other hardware devices. The non-transitory, machine readable medium 1460 may include instructions to direct the processor 1452 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

### EXAMPLES

The following examples pertain to further embodiments.

Example 1 is a system for double real-time bidding at a brick and mortar store, comprising an electronic sign disposed within the brick and mortar store to display electronic messages; and a shopper tracking system to collect shopping behavior data and bids from, and track a physical location of, each shopper of a plurality of shoppers while the plurality of shoppers are in the brick and mortar store, wherein the shopper tracking system is to notify a real-time bidding system when the plurality of shoppers is within a predetermined distance to the electronic sign, including providing the shopping behavior data of the plurality of shoppers; wherein on being notified, the real-time bidding system is to select, on the basis of the shopping behavior data of the plurality of shoppers, and display, an electronic message offering an item available from a plurality of sellers in or during a message slot of the electronic sign for the plurality of shoppers; and select, based on bids to sell the item from the plurality of sellers and bids to buy the item from the plurality of shoppers, a subset of the plurality of sellers to complete transactions for a plurality of the item with a subset of the plurality of shoppers.

Example 2 may include the subject matter of example 1, wherein the shopper tracking system includes a shopping behavior data collector to collect the shopping behavior data via RFID signal interference, the RFID signal interference generated by each of the plurality of shoppers as each shopper passes between an RFID tag disposed upon an item within the brick and mortar store and an RFID reader in communication with the shopping behavior data collector.

Example 3 may include the subject matter of example 1, wherein the shopper tracking system includes a shopper tracker that tracks each shopper's physical location using a physical device unique to and in the physical possession of each shopper.

Example 4 may include the subject matter of example 3, wherein the physical device unique to and in the physical possession of each shopper comprises a smartphone.

Example 5 may include the subject matter of example 4, wherein the shopper tracking system further includes a communication interface to receive bids from each of the plurality of shoppers via an application on the smartphone.

Example 6 may include the subject matter of example 4, wherein the shopper tracker uses the smartphone in the physical possession of each shopper to track each shopper's physical location via a combination of sensors within the smartphone and wireless characteristics of the smartphone.

Example 7 may include the subject matter of example 1, wherein the subset of the plurality of sellers and the subset of the plurality of buyers are selected on the basis of bids to sell each of the plurality of items at or below a determined price, and the bids to buy each of the plurality of items at or above the determined price, the determined price being that price that results in the largest subset of the plurality of buyers that is equal to the subset of the plurality of sellers.

Example 8 may include the subject matter of any one of examples 1-6, wherein the shopper tracking system includes a shopping behavior data collector that collects the shopping behavior data using computer vision.

Example 9 may include the subject matter of any one of examples 1-6, wherein the message slot of the electronic sign comprises a specified time window during which the electronic message is displayed for the plurality of shoppers.

Example 10 may include the subject matter of any one of examples 1-6, wherein the message slot of the electronic sign comprises a physical area that is at least a portion of a display on the electronic sign within which the electronic message is displayed.

Example 11 is a method for providing real-time double-auction bidding at a brick and mortar store, comprising collecting, by a shopper tracking system disposed within the brick and mortar store, shopping behavior data from each of a plurality of shoppers within the brick and mortar store; tracking, by the shopper tracking system, a physical location of each of the plurality of shoppers within the brick and mortar store; communicating, by the shopper tracking system, the shopping behavior data and physical location of each of the plurality of shoppers to a real time bidding system remote from the brick and mortar store; notifying, by the shopper tracking system, the real time bidding system when the plurality of shoppers shopper is within a predetermined distance to an electronic sign, to cause the real time bidding system to select, on the basis of the shopping behavior data, and display an electronic message conveying an offer for an item offered by a plurality of sellers in or during a message slot of the electronic sign for the shopper; receive bids to sell the item from the plurality of sellers and bids to buy the item from the plurality of shoppers; and select, based on the bids to sell the item and the bids to buy the item, a subset of the plurality of sellers to complete a transaction for a plurality of the item with a subset of the plurality of shoppers.

Example 12 may include the subject matter of example 11, wherein the each of the plurality of shoppers' physical location is tracked using a physical device unique to and in the physical possession of each of the plurality of shoppers.

Example 13 may include the subject matter of example 12, wherein the physical device unique to and in the physical possession of each of the plurality of shoppers comprises a smartphone.

Example 14 may include the subject matter of example 13, further comprising receiving, by the shopper tracking system, the bids to buy the item from each of the plurality of shoppers via an app on the smartphone.

Example 15 may include the subject matter of example 14, wherein the physical location of each of the plurality of shoppers is tracked via a combination of sensors within the smartphone in the physical possession of each shopper and wireless characteristics of the smartphone.

Example 16 may include the subject matter of example 11, wherein the shopping behavior data is collected via RFID signal interference, the RFID signal interference generated by each of the plurality of shoppers as each shopper passes between an RFID tag disposed upon an item within the brick and mortar store and an RFID reader in communication with the shopping behavior data collector.

Example 17 may include the subject matter of any one of examples 11-16, wherein the shopping behavior data is collected using computer vision.

Example 18 may include the subject matter of any one of examples 11-16, wherein the message slot of the electronic sign comprises a specified time window during which the electronic message is displayed for the plurality of shoppers.

Example 19 may include the subject matter of any one of examples 11-16, wherein the message slot of the electronic sign comprises a physical area that is at least a portion of a display on the electronic sign within which the electronic message is displayed.

Example 20 is a non-transitory computer-readable medium (CRM) comprising instructions to cause a shopper tracking system at a brick and mortar store, in response to execution of the instructions by a processor, to collect shopping behavior data from each of a plurality of shoppers within the brick and mortar store; track a physical location of each of the plurality of shoppers within the brick and mortar store; communicate the shopping behavior data and physical location of each of the plurality of shoppers to a real time bidding system remote from the brick and mortar store; notify the real time bidding system when the plurality of shoppers shopper is within a predetermined distance to an electronic sign, to cause the real time bidding system to select, on the basis of the shopping behavior data, and display an electronic message conveying an offer for an item offered by a plurality of sellers in or during a message slot of the electronic sign for the shopper; receive bids to sell the item from the plurality of sellers and bids to buy the item from the plurality of shoppers; and select, based on the bids to sell the item and the bids to buy the item, a subset of the plurality of sellers to complete a transaction for a plurality of the item with a subset of the plurality of shoppers.

Example 21 may include the subject matter of example 20, wherein the each of the plurality of shoppers' physical location is tracked using a physical device unique to and in the physical possession of each of the plurality of shoppers.

Example 22 may include the subject matter of example 21, wherein the physical device unique to and in the physical possession of each of the plurality of shoppers comprises a smartphone.

Example 23 may include the subject matter of example 22, wherein the bids to buy the item are received by the shopper tracking system from each of the plurality of shoppers via an app on the smartphone.

Example 24 may include the subject matter of example 23, wherein the physical location of each of the plurality of shoppers is tracked via a combination of sensors within the smartphone in the physical possession of each shopper and wireless characteristics of the smartphone.

Example 25 may include the subject matter of example 20, wherein the shopping behavior data is collected via RFID signal interference, the RFID signal interference generated by each of the plurality of shoppers as each shopper passes between an RFID tag disposed upon an item within the brick and mortar store and an RFID reader in communication with the shopping behavior data collector.

Example 26 may include the subject matter of any one of examples 20-25, wherein the shopping behavior data is collected using computer vision.

Example 27 may include the subject matter of any one of examples 20-25, wherein the message slot of the electronic sign comprises a specified time window during which the electronic message is displayed for the plurality of shoppers.

Example 28 may include the subject matter of any one of examples 20-25, wherein the message slot of the electronic sign comprises a physical area that is at least a portion of a display on the electronic sign within which the electronic message is displayed.

Example 29 is a system for real-time double auction bidding at a brick and mortar store, comprising display means disposed within the brick and mortar store to display electronic messages; shopper tracking means for collecting shopping behavior data and bids from, and track a physical location of, each shopper of a plurality of shoppers while the plurality of shoppers are in the brick and mortar store; wherein the shopper tracking means includes means for providing the shopping behavior data and physical location of each of the plurality of shoppers to a real time bidding means remote from the brick and mortar store; and means for providing a notification to the real time bidding means when the plurality of shoppers is within a predetermined distance to the electronic sign, to cause the real time bidding means to select, on the basis of the shopping behavior data, and display an electronic message offering an item available from a plurality of sellers in or during a message slot of the display means for the plurality of shoppers; and select, based on bids to sell the item from the plurality of sellers and bids to buy the item from the plurality of shoppers, a subset of the plurality of sellers to complete a transaction for a plurality of the item with a subset of the plurality of shoppers.

Example 30 may include the subject matter of example 29, wherein the shopper tracking means includes a shopping behavior data collection means to collect the shopping behavior data via RFID signal interference, the RFID signal interference generated by each of the plurality of shoppers as each shopper passes between an RFID tag disposed upon an item within the brick and mortar store and an RFID reader in communication with the shopping behavior data collector.

Example 31 may include the subject matter of example 29, wherein the shopper tracking means tracks each shopper's physical location using a physical device unique to and in the physical possession of each shopper.

Example 32 may include the subject matter of example 31, wherein the physical device unique to and in the physical possession of each shopper comprises a smartphone.

Example 33 may include the subject matter of example 32, wherein the shopper tracking means further includes a communication means to receive bids from each of the plurality of shoppers via an application on the smartphone.

Example 34 may include the subject matter of example 32, wherein the shopper tracking means uses the smartphone in the physical possession of each shopper to track each shopper's physical location via a combination of sensors within the smartphone and wireless characteristics of the smartphone.

Example 35 may include the subject matter of example 29, wherein the subset of the plurality of sellers and the subset of the plurality of buyers are selected on the basis of bids to sell each of the plurality of items at or below a determined price, and the bids to buy each of the plurality of items at or above the determined price, the determined price being that price that results in the largest subset of the plurality of buyers that is equal to the subset of the plurality of sellers.

Example 36 may include the subject matter of any one of examples 29-35, wherein the shopper tracking means includes a shopping behavior data collection means that collects the shopping behavior data using computer vision.

Example 37 may include the subject matter of any one of examples 29-35, wherein the message slot of the electronic sign comprises a specified time window during which the electronic message is displayed for the plurality of shoppers.

Example 38 may include the subject matter of any one of examples 29-35, wherein the message slot of the electronic sign comprises a physical area that is at least a portion of a display on the electronic sign within which the electronic message is displayed.

What is claimed is:

1. A system for double real-time bidding at a brick and mortar store, comprising:
an electronic sign disposed within the brick and mortar store to display electronic messages; and
a shopper tracking system to collect shopping behavior data and bids from, and track a physical location of, each shopper of a plurality of shoppers while the plurality of shoppers are in the brick and mortar store, wherein the shopper tracking system is to notify a real-time bidding system when the plurality of shoppers is within a predetermined distance to the electronic sign, including providing the shopping behavior data of the plurality of shoppers;
wherein on being notified, the real-time bidding system is to:
select, on the basis of the shopping behavior data of the plurality of shoppers, and display, an electronic message offering an item available from a plurality of sellers in or during a message slot of the electronic sign for the plurality of shoppers; and
select, based on bids to sell the item from the plurality of sellers and bids to buy the item from the plurality of shoppers, a subset of the plurality of sellers to complete transactions for a plurality of the item with a subset of the plurality of shoppers.

2. The system of claim 1, wherein the shopper tracking system includes a shopping behavior data collector to collect the shopping behavior data via RFID signal interference, the RFID signal interference generated by each of the plurality of shoppers as each shopper passes between an RFID tag disposed upon an item within the brick and mortar store and an RFID reader in communication with the shopping behavior data collector.

3. The system of claim 1, wherein the shopper tracking system includes a shopper tracker that tracks each shopper's physical location using a physical device unique to and in the physical possession of each shopper.

4. The system of claim 3, wherein the physical device unique to and in the physical possession of each shopper comprises a smartphone.

5. The system of claim 4, wherein the shopper tracking system further includes a communication interface to receive bids from each of the plurality of shoppers via an application on the smartphone.

6. The system of claim 4, wherein the shopper tracker uses the smartphone in the physical possession of each shopper to track each shopper's physical location via a combination of sensors within the smartphone and wireless characteristics of the smartphone.

7. The system of claim 1, wherein the subset of the plurality of sellers and the subset of the plurality of buyers are selected on the basis of bids to sell each of the plurality of items at or below a determined price, and the bids to buy each of the plurality of items at or above the determined price, the determined price being that price that results in the largest subset of the plurality of buyers that is equal to the subset of the plurality of sellers.

8. The system of claim 1, wherein the shopper tracking system includes a shopping behavior data collector that collects the shopping behavior data using computer vision.

9. The system of claim 1, wherein the message slot of the electronic sign comprises a specified time window during which the electronic message is displayed for the plurality of shoppers.

10. The system of claim 1, wherein the message slot of the electronic sign comprises a physical area that is at least a portion of a display on the electronic sign within which the electronic message is displayed.

11. A method for providing real-time double-auction bidding at a brick and mortar store, comprising:
collecting, by a shopper tracking system disposed within the brick and mortar store, shopping behavior data from each of a plurality of shoppers within the brick and mortar store;
tracking, by the shopper tracking system, a physical location of each of the plurality of shoppers within the brick and mortar store;
communicating, by the shopper tracking system, the shopping behavior data and physical location of each of the plurality of shoppers to a real time bidding system remote from the brick and mortar store;
notifying, by the shopper tracking system, the real time bidding system when the plurality of shoppers shopper is within a predetermined distance to an electronic sign, to cause the real time bidding system to:
select, on the basis of the shopping behavior data, and display an electronic message conveying an offer for an item offered by a plurality of sellers in or during a message slot of the electronic sign for the shopper;
receive bids to sell the item from the plurality of sellers and bids to buy the item from the plurality of shoppers; and
select, based on the bids to sell the item and the bids to buy the item, a subset of the plurality of sellers to complete a transaction for a plurality of the item with a subset of the plurality of shoppers.

12. The method of claim 11, wherein the shopping behavior data is collected via RFID signal interference, the RFID signal interference generated by each of the plurality of shoppers as each shopper passes between an RFID tag disposed upon an item within the brick and mortar store and an RFID reader in communication with the shopping behavior data collector.

13. A non-transitory computer-readable medium (CRM) comprising instructions to cause a shopper tracking system at a brick and mortar store, in response to execution of the instructions by a processor, to:
collect shopping behavior data from each of a plurality of shoppers within the brick and mortar store;
track a physical location of each of the plurality of shoppers within the brick and mortar store;
communicate the shopping behavior data and physical location of each of the plurality of shoppers to a real time bidding system remote from the brick and mortar store;
notify the real time bidding system when the plurality of shoppers shopper is within a predetermined distance to an electronic sign, to cause the real time bidding system to:
select, on the basis of the shopping behavior data, and display an electronic message conveying an offer for an item offered by a plurality of sellers in or during a message slot of the electronic sign for the shopper;
receive bids to sell the item from the plurality of sellers and bids to buy the item from the plurality of shoppers; and
select, based on the bids to sell the item and the bids to buy the item, a subset of the plurality of sellers to complete a transaction for a plurality of the item with a subset of the plurality of shoppers.

14. The CRM of claim 13, wherein the each of the plurality of shoppers' physical location is tracked using a physical device unique to and in the physical possession of each of the plurality of shoppers.

15. The CRM of claim 14, wherein the physical device unique to and in the physical possession of each of the plurality of shoppers comprises a smartphone.

16. The CRM of claim 15, wherein the bids to buy the item are received by the shopper tracking system from each of the plurality of shoppers via an app on the smartphone.

17. The CRM of claim 13, wherein the shopping behavior data is collected via RFID signal interference, the RFID signal interference generated by each of the plurality of shoppers as each shopper passes between an RFID tag disposed upon an item within the brick and mortar store and an RFID reader in communication with the shopping behavior data collector.

18. A system for real-time double auction bidding at a brick and mortar store, comprising:
display means disposed within the brick and mortar store to display electronic messages;
shopper tracking means for collecting shopping behavior data and bids from, and track a physical location of, each shopper of a plurality of shoppers while the plurality of shoppers are in the brick and mortar store;
wherein the shopper tracking means includes:
means for providing the shopping behavior data and physical location of each of the plurality of shoppers to a real time bidding means remote from the brick and mortar store; and
means for providing a notification to the real time bidding means when the plurality of shoppers is within a predetermined distance to the electronic sign, to cause the real time bidding means to:
select, on the basis of the shopping behavior data, and display an electronic message offering an item available from a plurality of sellers in or during a message slot of the display means for the plurality of shoppers; and
select, based on bids to sell the item from the plurality of sellers and bids to buy the item from the plurality of shoppers, a subset of the plurality of sellers to complete a transaction for a plurality of the item with a subset of the plurality of shoppers.

19. The system of claim 18, wherein the shopper tracking means includes a shopping behavior data collection means to collect the shopping behavior data via RFID signal interference, the RFID signal interference generated by each of the plurality of shoppers as each shopper passes between an RFID tag disposed upon an item within the brick and mortar store and an RFID reader in communication with the shopping behavior data collector.

20. The system of claim 18, wherein the shopper tracking means tracks each shopper's physical location using a physical device unique to and in the physical possession of each shopper.

21. The system of claim 20, wherein the physical device unique to and in the physical possession of each shopper comprises a smartphone.

22. The system of claim 21, wherein the shopper tracking means further includes a communication means to receive bids from each of the plurality of shoppers via an application on the smartphone.

23. The system of claim 21, wherein the shopper tracking means uses the smartphone in the physical possession of each shopper to track each shopper's physical location via a combination of sensors within the smartphone and wireless characteristics of the smartphone.

24. The system of claim 18, wherein the subset of the plurality of sellers and the subset of the plurality of buyers are selected on the basis of bids to sell each of the plurality of items at or below a determined price, and the bids to buy each of the plurality of items at or above the determined price, the determined price being that price that results in the largest subset of the plurality of buyers that is equal to the subset of the plurality of sellers.

25. The system of claim 18, wherein the shopper tracking means includes a shopping behavior data collection means that collects the shopping behavior data using computer vision.
